(19) United States
(12) Patent Application Publication
(10) Pub. No.: US 2026/0081126 A1
(43) Pub. Date: Mar. 19, 2026

(54) QUANTUM LOGIC SPECTROSCOPY SYSTEM

(71) Applicant: Oxford Ionics Limited, Begbroke (GB)

(72) Inventor: Robert Tyler SUTHERLAND, Austin, TX (US)

(21) Appl. No.: 18/799,318

(22) Filed: Aug. 9, 2024

(51) Int. Cl. H01J 49/00; H01J 49/42

(52) U.S. Cl. CPC H01J 49/0036; H01J 49/4205

(57) ABSTRACT

A quantum logic spectroscopy system for an ion trap configured to trap a primary ion and a detection ion, the quantum logic spectroscopy system configured to apply one or more conditioning operations, each of the one or more conditioning operations comprising applying a mapping operation to map a primary ion state of the primary ion on to a detection ion state of the detection ion, applying a state change operation comprising changing the detection ion state if the detection ion state has a first detection state value, and determine a probability of the detection ion state changing in response to the application of the state change operation, and determine the primary ion state using the determined probability or determine that the primary ion state is indeterminate using the determined probability.

The present disclosure relates to a quantum logic spectroscopy system for an ion trap.

### BACKGROUND

Quantum logic spectroscopy is a technique that maps quantum information from a first trapped ion to a second trapped ion. The quantum information of the first trapped ion may then be determined by measurement of the second trapped ion.

Quantum logic spectroscopy may be applied for state readout and state initialisation.

State readout refers to the process of determining the quantum state of an ion. State initialisation refers to the process of setting the quantum state of an ion to a specific value before undertaking subsequent quantum operations, for example, in a quantum computer. State readout may be undertaken as part of a state initialisation process to verify the ion has been correctly initialised.

Quantum logic spectroscopy systems are subject to the following two sources of error, which impact the accuracy of the state readout and state initialisation procedures:
quantum logic spectroscopy phase errors
quantum logic spectroscopy population state transfer errors

### SUMMARY

It is desirable to provide an improved quantum logic spectroscopy system that exhibits a higher fidelity than known systems.

According to a first aspect of the disclosure there is provided a quantum logic spectroscopy system for an ion trap configured to trap a primary ion and a detection ion, the quantum logic spectroscopy system configured to apply one or more conditioning operations, each of the one or more conditioning operations comprising applying a mapping operation to map a primary ion state of the primary ion on to a detection ion state of the detection ion, applying a state change operation comprising changing the detection ion state if the detection ion state has a first detection state value, and determine a probability of the detection ion state changing in response to the application of the state change operation, and determine the primary ion state using the determined probability or determine that the primary ion state is indeterminate using the determined probability.

Optionally, applying the state change operation comprises maintaining the detection ion state if the detection ion state has a second detection state value.

Optionally, the primary ion is a qubit ion or a qudit ion.

Optionally, the primary ion is a charged atom or a charged molecule.

Optionally, the detection ion is a charged atom or a charged molecule.

Optionally, the primary ion has a nuclear spin that is non-zero.

Optionally, the detection ion has a nuclear spin that is zero.

Optionally, the primary ion is a beryllium (Be) ion, a barium (Ba) ion or a calcium (Ca) ion.

Optionally, the detection ion is a calcium (Ca) ion or a strontium (Sr) ion.

Optionally, the primary ion state is a magnetic quantum number having one of two or more possible magnetic quantum number values comprising a first magnetic quantum number value and a second quantum magnetic number value.

Optionally, applying the mapping operation comprises setting the detection ion state to the first detection state value if the magnetic quantum number has the first magnetic quantum number value, and setting the detection ion state to a second detection state value if the magnetic quantum number has the second magnetic quantum number value.

Optionally, determining the probability comprises determining the probability for a first conditioning operation, and updating the probability for each subsequent conditioning operation until the probability converges, or a threshold number of repeated conditioning operations is exceeded.

Optionally, determining the probability comprises updating the probability for each subsequent conditioning operation until the probability converges to a 1 or a 0, or the threshold number of repeated conditioning operations is exceeded.

Optionally, the quantum logic spectroscopy system comprises a controller configured to apply the one or more conditioning operations by, for each of the one or more conditioning operations applying a first single rotation operation to the detection ion, applying a geometric phase gate to the primary ion and the detection ion, and applying a second single rotation operation to the detection ion.

Optionally, the quantum logic spectroscopy system comprises a detector configured to measure a property of the detection ion state for each of the one or more conditioning operations, wherein determining the probability of the detection ion state changing in response to the application of the state change operation uses the measured property of the detection ion state.

Optionally, the measured property of the detection ion state is whether the detection ion state has changed.

Optionally, the geometric phase gate is a ZZ gate.

Optionally, the controller comprises a magnetic field gradient generator configured to provide a magnetic field gradient to apply the geometric phase gate, and/or a control field generator configured to provide a control field to apply the first and second single rotation operations.

Optionally, the control field generator configured to provide a control field to apply the first single rotation operation by applying a first π/2 pulse, and apply the second single rotation operation by applying a second π/2 pulse.

Optionally, the control field generator comprises a microwave field generator and the control field is a microwave field.

Optionally, the magnetic field gradient, as provided by the magnetic field gradient generator, oscillates at, or near, a mode frequency of the ion chain comprising the primary ion and the detection ion, and/or the control field, as provided by the control field generator, oscillates at, or near, a detection ion transition frequency of the detection ion.

Optionally, the detection ion transition frequency and a transition frequency of the primary ion are unequal.

Optionally, the magnetic quantum number mf corresponds to the ground state hyperfine S manifold having one of 4I+2 possible magnetic quantum number values, where I is the nuclear spin of the primary ion.

Optionally, the probability of the detection ion state changing in response to the application of the state change operation is proportional to the magnetic quantum number mf squared, the probability will be 1 if, and only if, the primary ion state is the first magnetic quantum number value, the first magnetic quantum number value being the highest possible value of the magnetic quantum number mf, and the probability will be 0 if, and only if, the primary has state is the second magnetic quantum number value, the second magnetic quantum number value being the lowest possible value of the magnetic quantum number mf.

According to a second aspect of the disclosure there is provided an apparatus comprising a quantum logic spectroscopy system, and an ion trap configured to trap a primary ion and a detection ion, wherein the quantum logic spectroscopy system is configured to apply one or more conditioning operations, each of the one or more conditioning operations comprising applying a mapping operation to map a primary ion state of the primary ion on to a detection ion state of the detection ion, applying a state change operation comprising changing the detection ion state if the detection ion state has a first detection state value, and determine a probability of the detection ion state changing in response to the application of the state change operation, and determine the primary ion state using the determined probability or determine that the primary ion state is indeterminate using the determined probability.

Optionally, applying the state change operation comprises maintaining the detection ion state if the detection ion state has a second detection state value.

Optionally, the apparatus comprises a readout system comprising the quantum logic spectroscopy system, and/or an initialization system for initializing the primary ion state.

Optionally, determining the probability comprises determining the probability for a first conditioning operation, and updating the probability for each subsequent conditioning operation until the probability converges, or a threshold number of repeated conditioning operations is exceeded, wherein the initialization system is configured to reinitialize the primary ion state if the threshold number of repeated conditioning operations is exceeded.

Optionally, determining the probability comprises updating the probability for each subsequent conditioning operation until the probability converges to a 1 or a 0, or the threshold number of repeated conditioning operations is exceeded.

Optionally, the apparatus is a quantum computer.

It will be appreciated that the apparatus of the second aspect may include any of the features set out in the first aspect and can incorporate other features described herein.

According to a third aspect of the disclosure there is provided a method of controlling a quantum logic spectroscopy system for an ion trap configured to trap a primary ion and a detection ion, the method comprising applying one or more conditioning operations, each of the one or more conditioning operations comprising applying a mapping operation to map a primary ion state of the primary ion on to a detection ion state of the detection ion, applying a state change operation comprising changing the detection ion state if the detection ion state has a first detection state value, and determining a probability of the detection ion state changing in response to the application of the state change operation, and determining the primary ion state using the determined probability or determining that the primary ion state is indeterminate using the determined probability.

Optionally, applying the state change operation comprises maintaining the detection ion state if the detection ion state has a second detection state value. It will be appreciated that the method of the third aspect may include providing and/or using features set out in the first and/or second aspects, and can incorporate other features as described herein.

### BRIEF DESCRIPTION OF THE DRAWINGS

The disclosure is described in further detail below by way of example only and with reference to the accompanying drawings in which:

FIG. 1(a) is a schematic of a quantum logic spectroscopy system for an ion trap in accordance with a first embodiment of the present disclosure, FIG. 1(b) is a schematic of a specific embodiment of the quantum logic spectroscopy system in accordance with a second embodiment of the present disclosure, FIG. 1(c) is a schematic of a specific embodiment of the quantum logic spectroscopy system in accordance with a third embodiment of the present disclosure;

FIG. 2(a) is a schematic of an apparatus in accordance with a fourth embodiment of the present disclosure, FIG. 2(b) is a schematic of a specific embodiment of the apparatus in accordance with a fifth embodiment of the present disclosure; and

FIG. 3 is a flow chart of a method of controlling the quantum logic spectroscopy system, in accordance with a sixth embodiment of the present disclosure.

### DETAILED DESCRIPTION

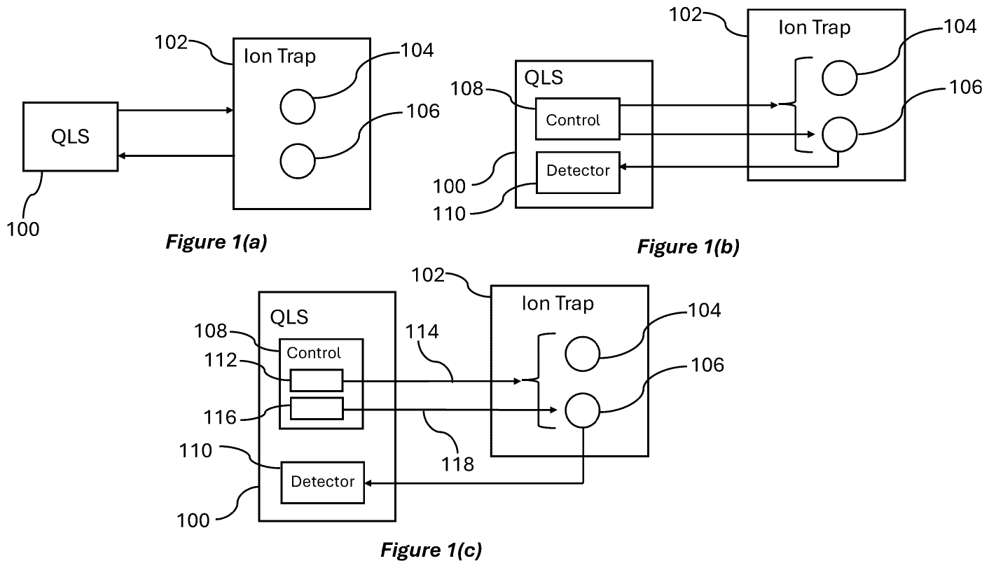

FIG. 1(a) is a schematic of a quantum logic spectroscopy system 100 for an ion trap 102 in accordance with a first embodiment of the present disclosure. In operation, the ion trap 102 traps a primary ion 104 and a detection ion 106.

The primary ion 104 may be used to store a unit of quantum information such as a qubit or a qudit. When storing a qubit, the primary ion 104 may be referred to as a qubit ion, and when storing a qudit, the primary ion 104 may be referred to as a qudit ion. In the present disclosure, examples are mainly provided in reference to the primary ion 104 functioning as a qubit ion. However, it will be appreciated that in further embodiments, the primary ion 104 may be used to store a different unit of quantum information (such as a qudit), in accordance with the understanding of the skilled person.

The detection ion 106 may be used to store a unit of quantum information such as a qubit or a qudit. The detection ion 106 may be referred to as a coolant ion or a readout ion.

In specific embodiments, the primary ion 104 is a charged atom or a charged molecule and/or the detection ion 106 is a charged atom or a charged molecule.

In specific embodiments, the primary ion 104 may have a nuclear spin that is non-zero and/or the detection ion 106 may have a nuclear spin that is zero.

In specific embodiments, the primary ion 104 may be, for example, a beryllium (Be) ion, a barium (Ba) ion or a calcium (Ca) ion. In specific embodiments the detection ion 106 may be a calcium (Ca) ion or a strontium (Sr) ion.

The quantum logic spectroscopy system 100 is configured to apply a conditioning operation. The conditioning operation comprises applying a mapping operation that maps a state of the primary ion 104 on to a state of the detection ion 106. The state of the primary ion 104 may be referred to as the “primary ion state” and the state of the detection ion 106 may be referred to as the “detection ion state”.

In a specific embodiment, the primary ion state mapped by the mapping operation is a magnetic quantum number, which may have one of two or more possible magnetic quantum number values comprising a first magnetic quantum number value and a second quantum magnetic number value.

The mapping operation may comprise setting the detection ion state to a first detection state value if the magnetic quantum number mf has the first magnetic quantum number value, and setting the detection ion state to a second detection state value of the magnetic quantum number mf has the second magnetic quantum number value.

The conditioning operation further comprises applying a state change operation to change the detection ion state if the detection ion state has the first detection state value. The conditioning operation may further comprise applying the state change operation to maintain the detection ion state at its present value if it has the second detection state value.

For example, the hyperfine manifold F comprises hyperfine sublevels. Hyperfine sublevels refer to specific values of the magnetic quantum number mf within the hyperfine manifold F.

For example, the primary ion state may be denoted by |F, m_{f}>. In a specific example the state may be |F=2, m_{f}=±2), and we may define the first magnetic quantum number value as +2 and the second magnetic quantum number value as −2. In the present example, we may also define the first detection state value as +2 and the second detection state value as −2, such that the mapping operation will act to set the detection ion state to +2 if the magnetic quantum number m_{f} is +2, and will set the detection ion state to −2 if the magnetic quantum number m_{f} is −2.

It will be appreciated that in the present example the direct mapping, such that the detection ion state is equal to the magnetic quantum number is to simplify the explanation, and in further embodiments, the mapping operation may set the detection ion state to a value that differs from that of the magnetic quantum number. The state change operation acts to change the detection ion state if the detection ion state has a specific first detection state value. In the present example, as we have defined the first detection state value as +2, assuming the detection ion state is +2, application of the state change operation will change the detection ion state from +2. Application of the state change operation may “flip” the state, for example, by setting the detection ion state to −2, which is the second detection state value.

Furthermore, assuming the detection ion state is −2, being the second detection state value, the state change operation will maintain the detection ion state as −2.

The quantum logic spectroscopy system 100 is further configured to determine the probability of the detection ion state changing in response to the application of the c state change operation. The quantum logic spectroscopy system 100 is further configured to determine the primary ion state based on the determined probability or to determine that the primary ion state is indeterminate using the determined probability.

The probability of the detection ion state changing is dependent on the primary ion state and therefore may be used to determine the primary ion state. For example, the magnetic quantum number m_{f} may be determined by measuring the probability of the detection ion state changing. The quantum logic spectroscopy system 100 avoids interrogating the primary ion 104, which could otherwise result in a change in the primary ion state. Specific embodiments of the system 100 may be used for state initialisation and/or state readout without measuring the primary ion 104 directly.

The conditioning operation may be repeated, with the probability being determined for a plurality of conditioning operations to improve the accuracy of the state determination.

In a specific embodiment, determining the probability may comprise determining the probability for an initial conditioning operation, with the probability being updated for subsequent conditioning operations. The probability may be updated until it converges, or until a threshold number of repeated conditioning operations is exceeded.

For example, the probability may be updated until it converges to a 1 or 0, or until the threshold number of repeated conditioning operations is exceeded.

With reference to the above example, assuming that the magnetic quantum number m_{f} is +2, repeated applications of the conditioning operations will result in the measured probability of the detection ion state changing converging to 1, thereby indicating that the magnetic quantum number m_{f} is +2. Similarly, repeated applications of the conditioning operations will result in the measured probability of the detection ion state changing converging to 0, thereby indicating that the magnetic quantum number m_{f} is −2.

For measurements where the probability does not converge to 1 or 0, this is indicative of the magnetic quantum number m_{f} having a value other than +2 or −2, such that the primary ion state is indeterminate. Therefore, the primary ion state may be determined as having a value other than the two intended values. Such a situation may occur as part of an initialisation process where the initialisation of the quantum information unit of the primary ion 104 has been unsuccessful, and initialisation may be repeated.

It will be appreciated that the conditioning operations are quantum operations and therefore probabilistic in nature. For example, we describe the mapping operation as mapping a state of one ion on to the state of another, which means that there is a high probability of this operation functioning as described, but a non-zero probability of the operation being unsuccessful. Similarly, the state change operation has a high probability of functioning as described, but a non-zero probability of being unsuccessful.

However, repeated application of the conditioning operation should result in the majority of operations functioning as described, thereby resulting in the determined probability of the detection ion state changing converging to a 1 or a 0, assuming that the primary ion state is not indeterminate.

It will be appreciated that in further embodiments, the probability may converge to a value other than 1 or 0. For example, assume optical pumping is used to prepare the primary ion 104, but the circular polarisation is non-optimal. In such an example, the primary ion 104 is most likely to be in m_{f}=F+, but also has a non-zero probability to be in m_{f}=F+−1, and a non-zero probability to be in m_{f}=F+−2. In such an example, converging of the probability to 0.9, can indicate that the primary ion 104 is likely in m_{f}=F+−1.

In a specific embodiment, after many operations, the value of probability will converge to a unique value for every possible m_{f} in the system. If the probability indicates m_{f}=F+ or m_{f}=F−, then the state is known exactly. If the probability converges to another value, it will still indicate m_{f}, but this will only narrow the state down to two possible states: |F+,m_{f}> and |F−,m_{f}>.

FIG. 1(b) is a schematic of a specific embodiment of the quantum logic spectroscopy system 100 in accordance with a second embodiment of the present disclosure.

In the present embodiment, the quantum logic spectroscopy system 100 comprises a controller 108 that is configured to apply the one or more conditioning operations. During operation, and for each of the conditioning operations, the controller 108 applies a first single rotation operation to the detection ion 106, applies a geometric phase gate to the primary ion 104 and the detection ion 106, and applies a second single rotation operation to the detection ion 106. The single rotation operations may be single qubit rotations.

The geometric phase gate may be an entangling gate. For high-fidelity two qubit gates, a geometric phase gate is called an MS gate if it gives a XX or YY like interaction, and a ZZ gate if it gives a ZZ rotation.

In embodiments of the present disclosure the geometric phase gate is a ZZ gate. The use of a ZZ gate means that the value of the magnetic quantum number m_{f} for each hyperfine sublevel will be projected onto the spin of the detection ion 106. This would not be the case for an MS gate since the fields need to be tuned for a specific transition. Additionally, implementing an MS gate would require using fields that are tuned near to a specific transition frequency in the atom, meaning that population transfer errors may be possible. However, the ZZ implementation of this technique contains no frequencies near any transition for the qubit. Therefore, the ZZ gate will be able to converge to much higher fidelities, when compared with known systems, after many repetitions.

In a specific embodiment, where the geometric phase gate is a ZZ gate, the gradient is tuned to oscillate near the motional frequency of the gating mode.

In specific embodiments of the present disclosure, the combination of applying the ZZ gate and the single qubit rotations will flip the spin of the detection ion 106.

The quantum logic spectroscopy system 100 further comprises a detector 110 that is configured to measure a property of the detection ion 106 for each of the conditioning operations. Determining the probability of the detection ion state changing by the application of the state change operation uses the measured property. The measured property may be whether the detection ion state has changed.

For example, the detector 110 may detect the flipping of the detection ion state from +2 to −2, and similarly may detect that no flipping has occurred if the detection ion state is −2.

The detector 110 may comprise a laser-based detection system for detection, in accordance with the understanding of the skilled person.

FIG. 1(c) is a schematic of a specific embodiment of the quantum logic spectroscopy system 100, having a specific controller 108 embodiment, in accordance with a third embodiment of the present disclosure.

The controller 108 comprises a magnetic field gradient generator 112 that is configured to provide a magnetic field gradient 114 to both ions 104, 106 to apply the geometric phase gate. The controller 108 further comprises a control field generator 116 that is configured to provide a control field 118 to the detection ion 106 to apply the first and second single rotation operations.

The control field generator 112 is configured to provide the first single rotation operation by applying a first π/2 pulse, and apply the second single rotation operation by applying a second π/2 pulse.

The control field generator 116 may comprise a microwave field generator, such that the control field 118 is a microwave field. The microwave control field 118 may, for example, have a frequency in the GHz frequency range.

The magnetic field gradient 114 may oscillate at, or near, a mode frequency of the ion chain comprising the primary ion 104 and the detection ion 106. The mode frequency is the frequency of the collective motion shared by both the primary ion 104 and the detection ion 106. This essentially acts as a ‘bus’ for information during the gate interaction.

For a two ion crystal, there will be six modes of motion and embodiments of the present disclosure are agnostic to which mode is used. The gate mode frequency is one of the motional frequency modes. Specific embodiments of the present disclosure have the system tuned near one of the modes for the gate, this is the gate mode. The word “mode” may refer to motion.

The control field 118 oscillates at, or near, a detection ion transition frequency of the detection ion 106. The detection ion transition frequency and a transition frequency of the primary ion 104 are preferably unequal.

The transition frequency is the frequency of any electronic transition internal to either ion 104, 106. There are infinitely many transition frequencies in every atom. Embodiments of the present disclosure avoid using control fields near any transition frequency in the primary ion 104 specifically. The single qubit rotations are tuned to a transition in the detection ion 106, which is preferably detuned from any transition in the primary ion 104.

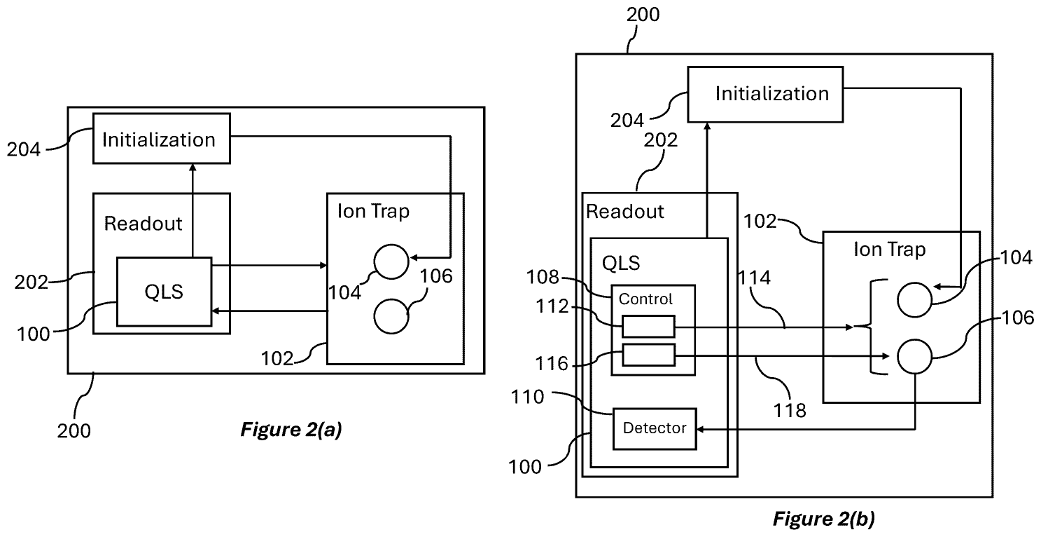

FIG. 2(a) is a schematic of an apparatus 200 in accordance with a fourth embodiment of the present disclosure. The apparatus 200 comprises the quantum logic spectroscopy system 100 and the ion trap 102. The quantum logic spectroscopy system 100 and/or the ion trap 102 may be implemented as any of the embodiments described herein, in accordance with the understanding of the skilled person. The apparatus 200 may be a quantum computer.

In a specific embodiment, the apparatus 200 further comprises a readout system 202 and/or an initialization system 204. The readout system 202 comprises the quantum logic spectroscopy system 200. The initialization system 204 is suitable for initializing the primary ion state of the primary ion 104.

In a specific embodiment, during operation the initialization system 204 initializes the primary ion state of the primary ion 104. The initialization is assessed using the quantum logic spectroscopy system 100 to determine if the primary ion 104 has been initialized and is in an intended quantum state.

If the quantum logic spectroscopy system 100 determines that the initialization has failed, for example if the probability of the detection ion state flipping has not converged after a threshold number of repeated conditioning operations is exceeded, the initialization system may repeat the initialization process of the primary ion state. The procedure may be repeated until the quantum logic spectroscopy system 100 has verified that initialization has been successful.

As discussed previously, quantum logic spectroscopy systems are subject to phase errors and population state transfer errors. These errors sources may be summarised as follows:
Phase errors—if a quantum state is determined by the set of complex numbers associated with the probability amplitude of each basis state, a phase error is when the complex number deviates from its ideal value via g=exp(iφ) i.e. a phase of unit modules. In other words, a phase error means the phase of the basis state is wrong, but the probability of the atom being in the basis state is still correct.
Population transfer error is when the magnitude of the probability amplitude of a given basis state is wrong. For example, if a state is supposed to be in the |0> state but it actually has a non-zero probability of being in the | 1> state.

In general, quantum logic spectroscopy phase errors are significantly less important than errors that leave population in the wrong state, as is the case for population transfer errors. This is because, if the given quantum logic spectroscopy operation does not change the state of the primary ion 104, repeated operations should give the same result as the first, allowing us to indefinitely increase our knowledge of the primary ion state by averaging over many repetitions; if the operation changes the state of the primary ion state, however, we change the initial conditions of the gate and repetitions will not increase the fidelity. This is the limitation that has prevented prior quantum logic spectroscopy initialization schemes from achieving high fidelities with lasers, as such systems exhibit a high probability of population transfer errors.

Embodiments of the present disclosure ensure that population transfer is highly energy forbidden thereby allowing only for phase errors.

Specifically, embodiments of the present disclosure operate with no near-resonant fields for the primary ions 104. For example, the primary ion 104 interacts with the magnetic field gradient 114, having a frequency in the MHz frequency range (an “RF” field), but has a low probability of interacting with the microwave control field 118 that is tuned near the detection ion's 106 transition energy, thereby suppressing probability transfer errors in favour of phase errors.

Since phase errors can be suppressed indefinitely with repeated measurements and population transfer errors cannot, embodiments of the present disclosure are likely to converge to high fidelity with repeated operations.

Embodiments of the present disclosure may simplify operations and lead to higher fidelity when compared with known systems. Specifically, embodiments of the present disclosure can provide high fidelity as probability transfer errors are highly energy forbidden in the primary ion 104. Embodiments of the present disclosure may detect state leakage.

Physical Review Letters 128(16), 160503 (2022) demonstrates state readout during the normal operation of a quantum system when the possible energy states of the qubit ion are known in advance of measurement. Such a system requires the use of lasers.

The scheme as presented in Physical Review Letters 128(16), 160503 (2022) is unsuitable for state readout as part of a state initialization process, where the possible states are not known in advance of measurement.

In general, state readout during state initialization is more difficult than state readout during normal quantum operation, since the set of hyperfine sublevels we must distinguish as part of an initialization process is much larger.

Specifically, during the initialization process the number of possible sublevels may be provided by n=4I+2, where I is the spin of the nucleus of the atom; and during normal quantum operation, n=2. Therefore, in known systems, the fidelities of readout during initialization are poor when compared to state readout during normal quantum operations.

Hyperfine sublevels refer to a specific value of m_{f} within a given hyperfine manifold F. The value n is the total number of hyperfine sublevels. There are 2F+1 for each value of F. In the S (ground) state, the two values of F are I+J and I−J: [2(I+J)+1]+[2(I−J)+1]=4l+2

J is the spin-angular momentum of one electron (the valence electron) of the atom, F is the total angular momentum of the atom, and m_{f} is the projection of the total angular momentum along the magnetic field.

Embodiments of the present disclosure eliminate the need for lasers that directly target the qubit ion, other than for ionization, thereby freeing up our choice of qubit and reducing the laser overhead associated with scaling to larger systems. For example, beryllium (Be) is an appealing choice as a qubit ion because of its light mass and relatively simple energy structure, but its 313 nm S to P transition makes it unappealing for a quantum charge-coupled device (QCCD). Embodiments of the present disclosure may use microwaves for logical operations thereby eliminating the requirement for a 313 nm laser and enabling Be to be used as a qubit ion for QCCD. Operations that require lasers may be mapped to the detection ion.

The 313 nm transition is specific to Be. In general, every ion has an S to P transition with a specific wavelength associated with it. If the wavelength is less than approximately 400 nm, then in known systems, such an ion would be unsuitable for QCCD purposes. Embodiments of the present disclosure remove the need for the S to P transition of the qubit ion altogether, thereby having benefits for the prospects of Be and other atoms in QCCD systems. More broadly, the embodiments of the present disclosure may allow for the removal of the S to P laser thereby simplifying the computer architecture. In summary, embodiments of the present disclosure may provide a simple control scheme that is enabled by laser-free physics.

In summary, embodiments of the present disclosure do not require a 313 nm laser to perform quantum logic spectroscopy with Be. Embodiments of the present disclosure may eliminate the requirement for a 313 nm laser. The only fields that “talk” to the qubit using embodiments of the present disclosure are microwaves, and any lasers in the system only need to “talk” to the detection ion.

It will be appreciated that embodiments of the present disclosure are applicable to other qubit atoms, so long as their frequencies are very different from the detection ion. For example, the qubit ion may be a beryllium (Be) ion, a barium (Ba) ion or a calcium (Ca) ion . . . .

FIG. 2(b) is a schematic of a specific embodiment of the apparatus 200 in accordance with a fifth embodiment of the present disclosure. In the present embodiment, the apparatus 100 comprises a specific embodiment of the quantum logic spectroscopy system 100.

A specific example of the operation of the apparatus 200 of FIG. 2(b) is as follows. In the present example, the primary ion 104 and the detection ion 106 are both qubit ions. We may refer to the primary ion 104 as the qubit ion 104 and the detection ion 106 as the readout qubit 106.

The conditioning operation as applied by the controller 108 implements an entangling gate between the qubit ion 104 (with non-zero nuclear spin) and the nuclear spin-zero readout qubit 106, in a manner that changes the state of the readout qubit 106, conditioned on the magnetic quantum number m_{f} (linear Zeeman sensitivity) of the qubit ion 104. By conditioning the gate operation such that it “flips” the (Zeeman) state of the readout ion 106 if and only if the qubit ion 104 is in a hyperfine sublevel with a unique value of m_{f}, for example |F=2,m_f=±2> in the S1/2 hyperfine manifold of 137Ba+, we can determine the state of the qubit ion 104 by observing the probability P₁ of flipping the spin of the readout qubit 106.

In the present example, one tone is applied to an integrated circuit at ˜1 amp that oscillates near the gate mode frequency, detuned by an amount δ. For a mixed species crystal, one spin non-zero qubit ion 104 and one spin zero readout ion 106, results in a Hamiltonian:

$${H}_{z z} = ℏ ( {Ω}_{q} {\hat{J}}_{z} + {Ω}_{r} {\hat{σ}}_{z} ) ( {a}^{+} {e}^{i δ t} + a {e}^{- i δ t} ) \qquad ( 1 )$$

where Ĵ_{z} is the electron spin operator projected onto the qubit ion's 104 hyperfine manifold and \hat{σ}_{z} is the Pauli operator for the readout ion's 106 two ground states.

At integer multiples of t=2π/δ, the time propagator for this system is:

$$\hat{U} = exp ( 2 i {Ω}_{q} {Ω}_{r} {\hat{J}}_{z} {\hat{σ}}_{z} t / δ ) \qquad ( 2 )$$

If we perform π/2 pulses on the readout qubit 106 before and after we apply Û, we map σ_{z}→σₓ in the equation (1). Assuming the qubit ion 104 has a non-zero probability of being in any hyperfine sublevel (mixed or coherent), we can project the time propagator onto each state |F, m_{f} [symbol] , which gives a value proportional to m_{f}.

It will be appreciated that applying π/2 pulses is a known technique/terminology in atomic, molecular and optical physics. It means applying the operator:

$$\hat{U} = exp ( - i ϕ {\hat{σ}}_{x} / 2 ) \qquad ( 3 )$$

Where the pulses are timed such that φ=π/2. If a π/2 pulse is applied before and after an operation, this will change the effective Pauli operator for any unitary we sandwich between it. For example:

$${\hat{U}}^{{}_{+}} {\hat{σ}}_{z} \hat{U} = {\hat{σ}}_{y} \qquad ( 4 )$$

With tuning the value of ΩᵣΩ_{q}/δ, we can now write the time propagator in the form:

$$\hat{U} = exp ( \frac{i π {m}_{f}}{4 {F}^{+}} {\hat{σ}}_{x} ) \qquad ( 5 )$$

where F⁺ is the larger of the two angular momentum values.

By applying single qubit rotations to the readout qubit 106 before and after the ZZ gate, the magnetic quantum number m_{f} of the qubit ion 104 is mapped to the probability of changing the readout qubit's 106 state. The probability of measuring |1 [symbol] is:

$${P}_{1} = {sin}^{2} ( π [ {F}^{+} + {m}_{f} ] / 4 {F}^{+} ) \qquad ( 6 )$$

If we measure P₁=1, then we know the state is in |F⁺, F⁺ [symbol] , and if we measure P₁=0, we know the state is in |F⁺,−F⁺ [symbol] . If we measure any other value of P₁, then we cannot determine the state.

In summary, embodiments of the present disclosure condition the operation such that the maximum and minimum values of the magnetic quantum number m_{f} map onto changing the state of the detection ion 106 with probability 0 or 1.

By engineering the interactions and applying enough repetitions and/or measurements, it is possible to distinguish the magnetic quantum number m_{f} of the qubit ion 104, thereby determining its state.

For a state readout process as part of normal quantum operation, if the qubit ion 104 is magnetically sensitive, or if we shelve the qubit ion 104 such that it is sensitive prior to the above operation, this technique will straightforwardly allow us to map the magnetic sensitivity of the qubit ion 104 onto the readout qubit 106. Repeated operations would result in the probability converging, thereby providing high fidelity operation as discussed previously.

If used as part of an initialization process, the technique will allow us to determine the qubit ion's 104 state if it is in m_{f}=±F⁺. If the experiment does not return this value, we cannot distinguish the qubit ion's 104 state uniquely. In this case, we reset the qubit ion 104 and repeat the experiment, as discussed previously.

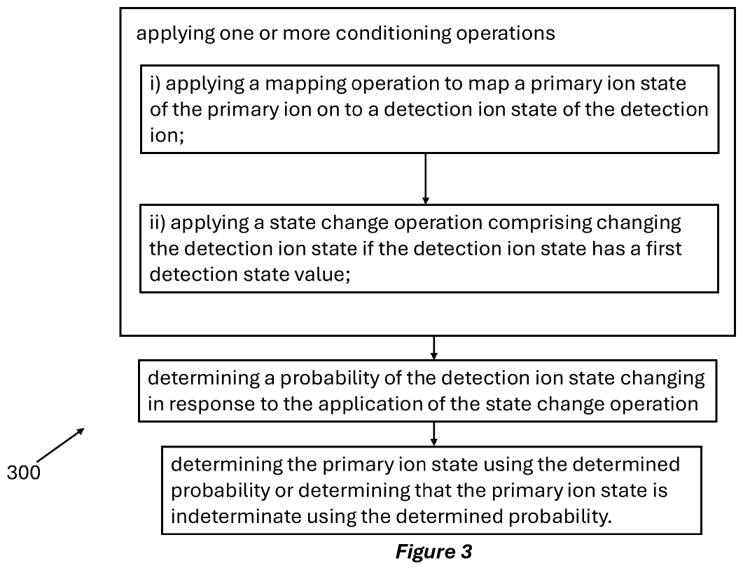

FIG. 3 is a flow chart of a method 300 of controlling the quantum logic spectroscopy system 100, in accordance with a sixth embodiment of the present disclosure.

Various improvements and modifications may be made to the above without departing from the scope of the disclosure.

1. A quantum logic spectroscopy system for an ion trap configured to trap a primary ion and a detection ion, the quantum logic spectroscopy system configured to:
apply one or more conditioning operations, each of the one or more conditioning operations comprising:
i) applying a mapping operation to map a primary ion state of the primary ion on to a detection ion state of the detection ion;
ii) applying a state change operation comprising changing the
detection ion state if the detection ion state has a first detection state value; and
determine a probability of the detection ion state changing in response to the application of the state change operation; and
determine the primary ion state using the determined probability or determine that the primary ion state is indeterminate using the determined probability.

2. The quantum logic spectroscopy system of claim 1, wherein applying the state change operation comprises maintaining the detection ion state if the detection ion state has a second detection state value.

3. The quantum logic spectroscopy system of claim 1, wherein the primary ion state is a magnetic quantum number having one of two or more possible magnetic quantum number values comprising a first magnetic quantum number value and a second quantum magnetic number value.

4. The quantum logic spectroscopy system of claim 3, wherein applying the mapping operation comprises:
setting the detection ion state to the first detection state value if the magnetic quantum number has the first magnetic quantum number value; and
setting the detection ion state to a second detection state value if the magnetic quantum number has the second magnetic quantum number value.

5. The quantum logic spectroscopy system of claim 1, wherein:
determining the probability comprises:
determining the probability for a first conditioning operation; and
updating the probability for each subsequent conditioning operation until:
i) the probability converges; or
ii) a threshold number of repeated conditioning operations is exceeded.

6. The quantum logic spectroscopy system of claim 5, wherein:
determining the probability comprises:
updating the probability for each subsequent conditioning operation until:
i) the probability converges to a 1 or a 0; or
ii) the threshold number of repeated conditioning operations is exceeded.

7. The quantum logic spectroscopy system of claim 1 comprising:
a controller configured to apply the one or more conditioning operations by, for each of the one or more conditioning operations:
i) applying a first single rotation operation to the detection ion;
ii) applying a geometric phase gate to the primary ion and the detection ion; and
iii) applying a second single rotation operation to the detection ion.

8. The quantum logic spectroscopy system of claim 7 comprising:
a detector configured to measure a property of the detection ion state for each of the one or more conditioning operations; wherein:
determining the probability of the detection ion state changing in response to the application of the state change operation uses the measured property of the detection ion state.

9. The quantum logic spectroscopy system of claim 8, wherein the measured property of the detection ion state is whether the detection ion state has changed.

10. The quantum logic spectroscopy system of claim 7, wherein the geometric phase gate is a ZZ gate.

11. The quantum logic spectroscopy system of claim 7, wherein the controller comprises:
a magnetic field gradient generator configured to provide a magnetic field gradient to apply the geometric phase gate; and/or
a control field generator configured to provide a control field to apply the first and second single rotation operations.

12. The quantum logic spectroscopy system of claim 11, wherein the control field generator configured to provide a control field to:
apply the first single rotation operation by applying a first π/2 pulse; and
apply the second single rotation operation by applying a second π/2 pulse.

13. The quantum logic spectroscopy system of claim 11, wherein the control field generator comprises a microwave field generator and the control field is a microwave field.

14. The quantum logic spectroscopy system of claim 11, wherein:
the magnetic field gradient, as provided by the magnetic field gradient generator, oscillates at, or near, a mode frequency of the ion chain comprising the primary ion and the detection ion; and/or
the control field, as provided by the control field generator, oscillates at, or near, a detection ion transition frequency of the detection ion.

15. The quantum logic spectroscopy system of claim 14, wherein the detection ion transition frequency and a transition frequency of the primary ion are unequal.

16. The quantum logic spectroscopy system of claim 3, wherein the magnetic quantum number m_{f} corresponds to the ground state hyperfine S manifold having one of 4I+2 possible magnetic quantum number values, where I is the nuclear spin of the primary ion.

17. The quantum logic spectroscopy system of claim 16, wherein:
the probability of the detection ion state changing in response to the application of the state change operation is proportional to the magnetic quantum number m_{f} squared;
the probability will be 1 if, and only if, the primary ion state is the first magnetic quantum number value, the first magnetic quantum number value being the highest possible value of the magnetic quantum number m_{f}; and
the probability will be 0 if, and only if, the primary has state is the second magnetic quantum number value, the second magnetic quantum number value being the lowest possible value of the magnetic quantum number m_{f}.

18. An apparatus comprising:
a quantum logic spectroscopy system; and
an ion trap configured to trap a primary ion and a detection ion; wherein:
the quantum logic spectroscopy system is configured to:
apply one or more conditioning operations, each of the one or more conditioning operations comprising:
i) applying a mapping operation to map a primary ion state of the primary ion on to a detection ion state of the detection ion;
ii) applying a state change operation comprising changing the detection ion state if the detection ion state has a first detection state value; and
determine a probability of the detection ion state changing in response to the application of the state change operation; and
determine the primary ion state using the determined probability or determine that the primary ion state is indeterminate using the determined probability.

19. The apparatus of claim 18, wherein applying the state change operation comprises maintaining the detection ion state if the detection ion state has a second detection state value.

20. The apparatus of claim 18, comprising:
a readout system comprising the quantum logic spectroscopy system; and/or
an initialization system for initializing the primary ion state.

21. The apparatus of claim 20, wherein:
determining the probability comprises:
i) determining the probability for a first conditioning operation; and
ii) updating the probability for each subsequent conditioning operation until:
a) the probability converges; or
b) a threshold number of repeated conditioning operations is exceeded; wherein:
the initialization system is configured to reinitialize the primary ion state if the threshold number of repeated conditioning operations is exceeded.

22. The apparatus of claim 21, wherein:
determining the probability comprises:
ii) updating the probability for each subsequent conditioning operation until:
a) the probability converges to a 1 or a 0; or
b) the threshold number of repeated conditioning operations is exceeded.

23. The apparatus of claim 18, wherein the apparatus is a quantum computer.

24. A method of controlling a quantum logic spectroscopy system for an ion trap configured to trap a primary ion and a detection ion, the method comprising:
applying one or more conditioning operations, each of the one or more conditioning operations comprising:
i) applying a mapping operation to map a primary ion state of the primary ion on to a detection ion state of the detection ion;
ii) applying a state change operation comprising changing the detection ion state if the detection ion state has a first detection state value; and
determining a probability of the detection ion state changing in response to the application of the state change operation; and
determining the primary ion state using the determined probability or determining that the primary ion state is indeterminate using the determined probability.
